(19) United States
(12) Patent Application Publication
(10) Pub. No.: US 2012/0154880 A1
(43) Pub. Date: Jun. 21, 2012

(54) OPTICAL MODULATORS

(76) Inventors: Wei Wu, Palo Alto, CA (US); Jingjing Li, Palo Alto, CA (US); Shih-Yuan Wang, Palo Alto, CA (US); Alexandre M. Bratkovski, Mountain View, CA (US); R. Stanley Williams, Portola Valley, CA (US)

(21) Appl. No.: 13/259,418

(22) PCT Filed: Sep. 10, 2009
(86) PCT No.: PCT/US09/56479

§ 371 Date: Sep. 23, 2011

(51) Int. Cl. G03H 1/08; G02F 1/01; G02F 1/015

(52) U.S. Cl. 359/9; 359/276; 359/279

(57) ABSTRACT

Various embodiments of the present invention are directed to external, electronically controllable modulators. In one embodiment, a modulating device (100,400) includes a first electrode (104,404), a second electrode (106,406), and an active region (102,402). The active region is configured so that at least a portion of the active region is disposed between the first electrode and the second electrode. Applying a voltage of an appropriate magnitude and polarity to the electrodes changes the conductivity of the active region which in turn shifts the phase and/or amplitude of electromagnetic radiation transmitted through the active region.

### TECHNICAL FIELD

Embodiments of the present invention relate to external modulators.

### BACKGROUND

An electromagnetic signal encodes information in high and low amplitude states or phase changes of a carrier wave of electromagnetic radiation. The electromagnetic signal can be transmitted over a waveguide, such as an optical fiber, or in free space. One way in which to generate an electromagnetic signal is to directly modulate the drive current of a laser or light-emitting diode (“LED”). This process of generating electromagnetic signals is called “direct modulation.” Unfortunately, direct modulation of radiation emitting devices has a number of drawbacks. First, the modulation rate averaged over power may be limited. Second, high and low amplitude states of an electromagnetic signal may be indistinguishable. Third, direct modulation can distort analog signals and shift the output wavelength of an electromagnetic signal, an effect called “chirp,” which adds to chromatic dispersion.

The importance of these limitations depends on the system design and the distance over which the electromagnetic signals are transmitted. For example, when an electromagnetic signal is transmitted over many kilometers, these problems can occur with direct modulation data rates as low as 1 Gbit/s. On the other hand, when an electromagnetic signal is transmitted less than a kilometer or two, direct modulation may be sufficient at data rates as high as 10 Gbit/s.

In either case, when direct modulation fails to meet performance requirements, external modulators (modulators) can be used. A modulator can be operated to encode information in an electromagnetic signal by passing an unmodulated carrier wave of electromagnetic radiation through the modulator with the modulator operated to change the phase and/or amplitude of the carrier wave. Modulators can be operated at faster modulation rates than direct modulation of a laser or an LED, and typically do not alter the wavelength of the electromagnetic radiation. In recent years, the demand for faster and more efficient modulators has increased in order to keep pace with the increasing demand for high speed data transmission between communicating devices.

### BRIEF DESCRIPTION OF THE DRAWINGS

FIG. 1 shows an isometric view of a first electronically modulating device configured in accordance with embodiments of the present invention.

FIGS. 2A-2B show cross-sectional views of the modulating device along a line I-I, shown in FIG. 1, configured in accordance with embodiments of the present invention.

FIGS. 3A-3B show cross-sectional views of the modulating device along the line I-I, shown in FIG. 1, configured in accordance with embodiments of the present invention.

FIG. 4 shows an isometric view of a second electronically modulating device configured in accordance with embodiments of the present invention.

FIGS. 5A-5B show cross-sectional views of the modulating device along a line II-II, shown in FIG. 4, in accordance with embodiments of the present invention.

FIGS. 6A-6B show cross-sectional views of the modulating device along the line II-II, shown in FIG. 4, in accordance with embodiments of the present invention.

FIG. 7 shows a cross-sectional view of an active region composed of an intrinsic material and a corresponding refractive index plot according to the present invention.

FIG. 8 shows a cross-sectional view of an active region composed of a doped material and a corresponding refractive index plot according to the present invention.

FIG. 9 shows a cross-sectional view of an active region with an uneven dopant distribution and a corresponding refractive index plot according to the present invention.

FIGS. 10A-10B simulation results characterizing amplitude and phase changes in electromagnetic radiation transmitted through an active region with a thickness of 30 nm in accordance with embodiments of the present invention.

FIGS. 11A-11B simulation results characterizing amplitude and phase changes in electromagnetic radiation transmitted through an active region with a thickness of 40 nm in accordance with embodiments of the present invention.

FIGS. 12A-12B show modulating devices operated as modulators in accordance with embodiments of the present invention.

FIGS. 13A-13E show examples of amplitude, phase, and amplitude/phase modulated electromagnetic signals.

FIG. 14 shows a schematic representation of a modulator inserted between an electromagnetic radiation source and an optical fiber collimator in accordance with embodiments of the present invention.

FIG. 15 shows a schematic representation of a modulator inserted between two fiber collimators in accordance with embodiments of the present invention.

FIG. 16 shows an isometric view of a first electronically controlled hologram configured in accordance with embodiments of the present invention.

FIG. 17 shows an isometric view of a second electronically controlled hologram configured in accordance with embodiments of the present invention.

FIG. 18 shows a side view of rays of electromagnetic radiation transmitted through three modulating devices of a hologram operated in accordance with embodiments of the present invention.

FIG. 19 shows a side view of electromagnetic radiation entering and emerging from a hologram in accordance with embodiments of the present invention.

FIG. 20 shows an example of a system for generating a three-dimensional color holographic image in accordance with embodiments of the present invention.

FIG. 21 shows intensity levels associated an intensity-control layer configured in accordance with embodiments of the present invention.

### DETAILED DESCRIPTION

Various embodiments of the present invention are directed to external, electronically controllable modulators. Modulator embodiments include a memristor material with at least of a portion of the material disposed between two electrodes. When a modulator is placed in the path of an unmodulated carrier wave of electromagnetic radiation, electronic signals applied to the modulator electrodes shift the memristor material refractive index resulting in corresponding phase and/or amplitude changes in the carrier wave. The resulting electromagnetic signal encodes the same information as the electronic signal. Various embodiments of the present invention also include modulators arranged in arrays to form electronically controlled holograms. By applying appropriate electronic signals to the modulators of an electronically controlled hologram, the wavefronts of electromagnetic radiation passing through the hologram can be controlled to create holographic images and can be dynamically controlled to generate three-dimensional motion pictures.

The detailed description is organized as follows: A description of electronically modulating devices configured in accordance with embodiments of the present invention is provided in a first subsection. A description of modulating device operation is provided in a second subsection. Using electronically modulating device for phase and/or amplitude modulation is provided in a fourth subsection. Applications for electronically modulating devices are provided in a fifth subsection.

### I. Electronically Modulating Devices

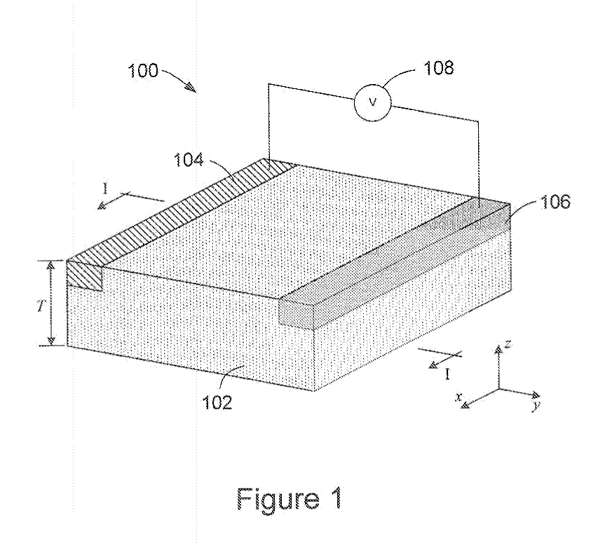

FIG. 1 shows an isometric view of an electronically controlled modulating device 100 configured in accordance with embodiments of the present invention. The device 100 includes an active region 102, a first electrode 104, and a second electrode 106. As shown in the example of FIG. 1, a portion of the electrodes 104 and 106 are embedded within the active region 102 and located on the same side of the active region 102 such that a subregion of the active region 102 is disposed between the electrodes 104 and 106. FIG. 1 also includes a voltage source 108 connected to the electrodes 104 and 106. The thickness of the active region 102, denoted by T, can range from about 20 nm to about 50 nm.

The active region 102 can be composed of various semiconductor materials, oxides, or nitrides in combination with a variety of different electrode materials. These combinations of materials provide a large engineering space from which electronically modulating devices 100 can be fabricated using various semiconductor fabrication techniques.

In certain embodiments, the active region 102 can be composed of an elemental and/or a compound semiconductor. Elemental semiconductors include silicon (“Si”), germanium (“Ge”), and diamond (“C”). Compound semiconductors include group IV compound semiconductors, III-V compound semiconductors, and II-VI compound semiconductors. Group IV compound semiconductors include combinations of elemental semiconductors, such as SiC and SiGe. III-V compound semiconductors are composed of column IIIa elements selected from boron (“B”), aluminum (“Al”), gallium (“Ga”), and indium (“In”) in combination with column Va elements selected from nitrogen (“N”), phosphorus (“P”), arsenic (“As”), and antimony (“Sb”). III-V compound semiconductors are classified according to the relative quantities of III and V elements, such as binary compound semiconductors, ternary compound semiconductors, and quaternary compound semiconductors. The active region 102 can be composed of other types of suitable compound semiconductors including II-VI ternary alloy semiconductors and II-V compound semiconductors.

In other embodiments, the active region 102 can be composed of an oxide containing one or more (mobile) oxygen atoms (“O”) and one or more other element. In particular, the active region 102 can be composed of titania (“TiO₂”), zirconia (“ZrO₂”), or hafnia (“HfO₂”). Other composition embodiments for the active region 102 include alloys of these oxides in pairs or with all three of the elements Ti, Zr, and Hf present. For example, the active region 102 can be composed of TiₓZr_{y}Hf_{z}O₂, where x+y+z=1. Related compounds include titanates, zirconates, and hafnates. For example, titanates includes ATiO₃, where A represents one of the divalent elements strontium (“Sr”), barium (“Ba”) calcium (“Ca”), magnesium (“Mg”), zinc (“Zn”), and cadmium (“Cd”). In general, the active region 102 can be composed of ABO₃, where A represents a divalent element and B represents Ti, Zr, and Hf. The active region 102 can also be composed of alloys of these various compounds, such as CaₐSr_{b}Ba_{c}TiₓZr_{y}Hf_{z}O₃, where a+b+c+2x+2y+2z=3. There are also a wide variety of other oxides of the transition and rare earth metals with different valences that may be used, both individually and as more complex compounds. The active region can also be composed of metal oxides or nitrides, such as RuO₂, IrO₂, and TiN, and titanates, such as SrTiO₃.

In addition to the large variety of semiconductor materials and oxides that can be used to form the active region 102, the electrodes 104 and 106 can be composed of platinum (“Pt”), gold (“Au”), copper (“Cu”), tungsten (“W”), or any other suitable metal, metallic compound (e.g. some perovskites with or without dopants such as BaTiO₃ and Ba₁₋ₓLaₓTiO_{3,} PrCaMnO₃) or semiconductor. The electrodes 104 and 106 can also be composed of metal, oxides or nitrides. The electrodes 104 and 106 can also be composed of any suitable combination of these materials. For example, in certain embodiments, the first electrode 104 can be composed of Pt, and the second electrode 106 can be composed Au. In other embodiments, the first electrode 104 can be composed of Ti, and the second electrode 106 can be composed of Pt or Cu. In still other embodiments, the first electrode 104 can be composed of a suitable semiconductor, and the second electrode 106 can be composed of Pt.

The materials selected for the active region 102 and the electrodes 104 and 106 can be determined by the manner in which the modulating device 100 is operated. For example, in certain embodiments, when the active region 102 is composed of a semiconductor material, the active region 102 can be doped with p-type impurities, also called dopants, which are atoms that introduce vacant electronic energy levels called “holes” to the electronic band gaps of the active region. These impurities or dopants arc “electron acceptors.” In still other embodiments, the active region 102 can be doped with n-type impurities, which are atoms that introduce filled electronic energy levels to the electronic band gap of the active region. These impurities or dopants are “electron donors.” For example, B, Al, and Ga are p-type dopants that introduce vacant electronic energy levels near the valence band of the elemental semiconductors Si and Ge; and P, As, and Sb are n-type dopants that introduce filled electronic energy levels near the conduction band of the elemental semiconductors Si and Ge. In III-V compound semiconductors, column VI elements substitute for column V atoms in the III-V lattice and serve as n-type dopants, and column II elements substitute for column III atoms in the III-V lattice to form p-type dopants.

In other embodiments, when the active region 102 is composed of an oxide, the dopant can be an oxygen vacancy, denoted by V_{O}. An oxygen vacancy effectively acts as a positively charged n-type dopant with one shallow and one deep energy level.

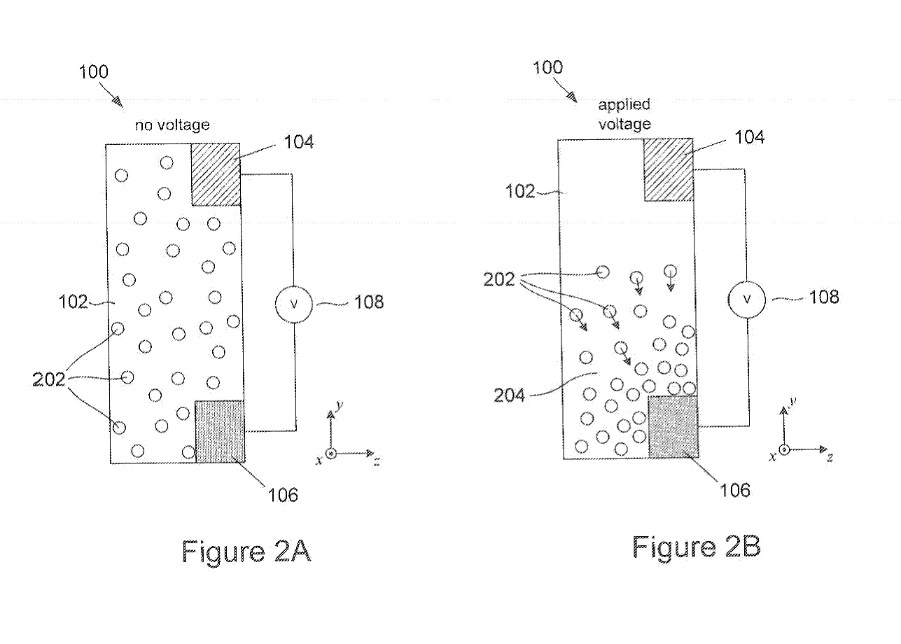

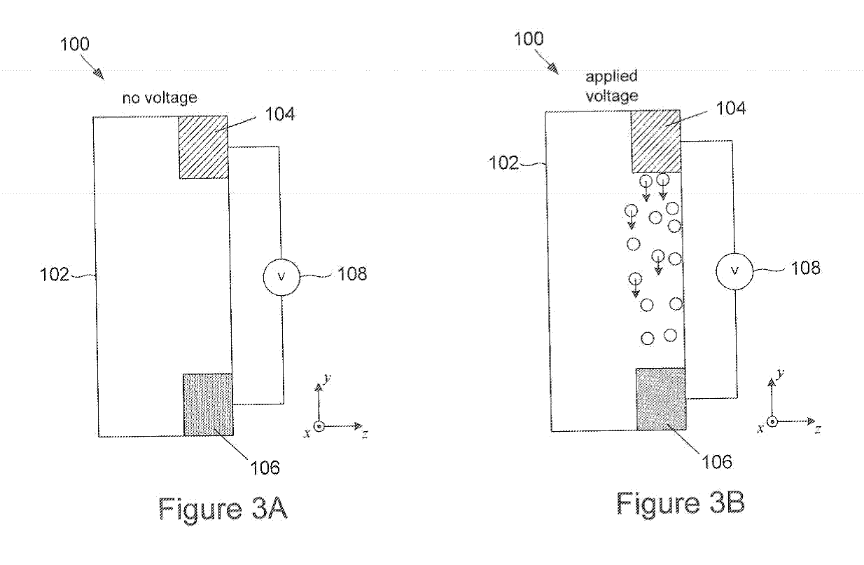

Modulating the distribution of dopant profiles may have a strong effect on the conductivity of the active region 102. FIGS. 2A-2B show cross-sectional views of the modulating device 100 along a line I-I, shown in FIG. 1, configured in accordance with embodiments of the present invention. In particular, FIG. 2A represents the device 100 where the active region 102 includes a dopant 202 dispersed throughout the active region 102. For example, the dopant 202 can be an n-type impurity or a p-type impurity when the active region 102 is composed of a semiconductor, or the dopant 202 can be an oxygen vacancy V₀ when the active region 102 is composed of an oxide. In the case of a semiconductor-based active region 102, dopants can be introduced during chemical deposition of the active region material. In the case of an oxide-based active region 102, oxygen vacancies are introduced by relatively minor variations in the stoichiometry of the active region material. For example, an active region 102 with about 0.1% oxygen vacancies represented by x in the oxide TiO₂₋ₓ, corresponds to about 5×10¹⁹ dopants/cm³. As shown in the example of FIG. 2B, when a voltage of an appropriate magnitude and polarity is applied to the electrodes 104 and 106, an electrical field forms, also called a “drift field,” between the electrodes 104 and 106. The dopants 202 become mobile in the active region 102 and can drift into a subregion 204 of the active region 102 near the second electrode 106. In other embodiments, a voltage with an appropriate magnitude and opposite polarity may cause the dopants to drift away from the electrode 106 and in order to distribute the dopants within the active region 102. In other embodiments, when the active region 102 is composed of an undoped, or intrinsic, material, one of the two electrodes 104 and 106 can be composed of doped semiconductor or a material that is suitable for introducing dopants to, or forming dopants within, the active region 102 while the other electrode can be composed of suitable conducting metal. FIGS. 3A-3B show cross-sectional views of the device 100 along the line I-I, shown in FIG. 1, configured in accordance with embodiments of the present invention. As shown in the example of FIG. 3A, the active region 102 is initially composed of an intrinsic semiconductor material or an intrinsic oxide, such as TiO₂ or ZrO₂. The first electrode 104 can be composed of a material that introduces dopants to the subregion of the active region 102 between the electrodes 104 and 106. For example, in certain embodiments, the electrode 104 can be composed of a semiconductor doped with an n-type impurity or a p-type impurity. As shown in the example of FIG. 3A, when a voltage of an appropriate magnitude and polarity is applied to the electrodes 104 and 106, the dopant 202 drifts from the electrode 104 into the subregion 204 of the active region 102. In other embodiments, the active region 102 can be composed of an intrinsic oxide and the electrode 104 can be composed of Ti, Zr, Hf, or an alloy of the oxide. For example, the electrode 104 can be composed of Ti and the active region 102 can be composed of TiO₂. FIG. 3B can also represent the case that when a voltage of an appropriate magnitude is applied to the electrodes 104 and 106, Ti⁺ ions, for example, drift from the electrode 104 into the subregion 206 of the active region 102 forming oxygen vacancies 202 in the subregion 206. Reversing the polarity of the voltage may cause Ti⁺ ions to drift back into the first electrode 104 depleting the active region 102 of oxygen vacancies.

In still other embodiments, the modulating device 100 can be fabricated with dopants, or metal ions that form dopants, concentrated in a reservoir in close proximity to the electrode 104. When a voltage of an appropriate magnitude and polarity is applied, the dopants can drift into the region 206, as shown in FIG. 3B. When the polarity of the voltage is reversed, the dopants or metal ions drift back reforming the reservoir in close proximity to the electrode 104.

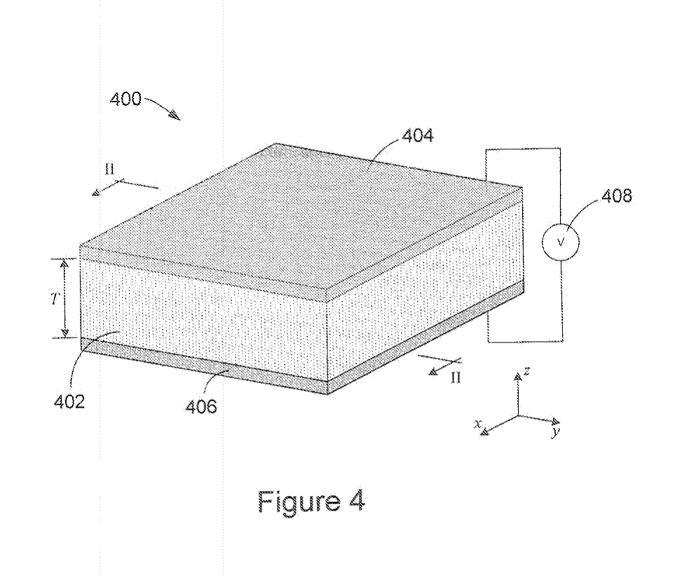

FIG. 4 shows an isometric view of an electronically controlled modulating device 400 configured in accordance with embodiments of the present invention. The device 400 includes an active region 402, a first electrode plate 404, and a second electrode plate 406. As shown in the example of FIG. 4, the electrodes 404 and 406 are located on opposite sides of the active region 402 with the active region 402 substantially filling the space between the electrodes 404 and 406. FIG. 4 includes a voltage source 408 electronically connected to the first and second electrodes 404 and 406. The thickness of the active region 402, denoted by T, can range from about 20 nm to about 50 nm.

The active region 402 and the electrodes 404 and 406 can be composed of substantially the same semiconductors, oxides, and metallic materials described above with reference to FIG. 1. The modulating device 400 can also be operated in the same manner as the modulating device 100.

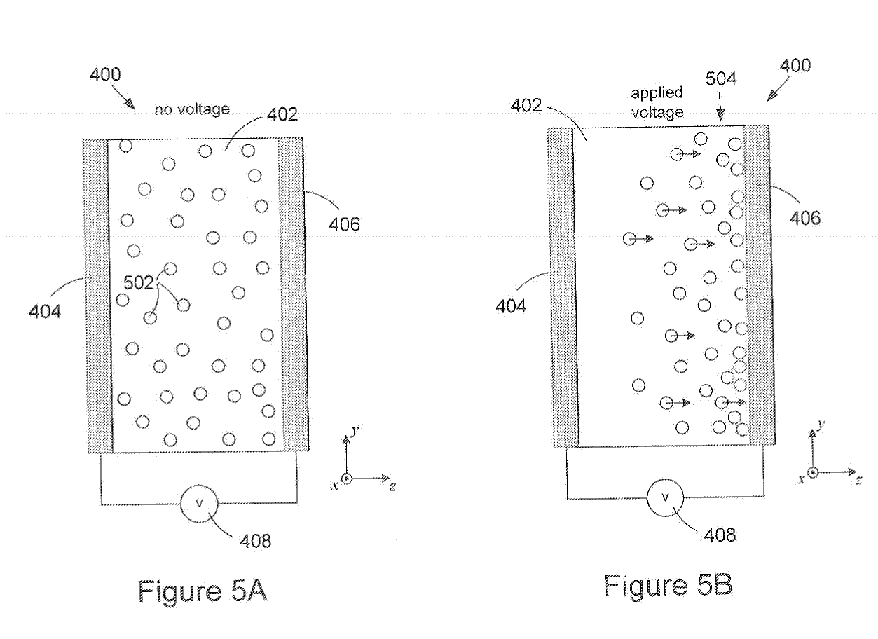

FIGS. 5A-5B show cross-sectional views of the device 400 along a line II-II, shown in FIG. 4, in accordance with embodiments of the present invention. In particular, FIG. 5A represents the device 400 where the active region 402 includes a dopant 502 dispersed throughout the active region 402. For example, the dopant 502 can be an n-type impurity or a p-type impurity when the active region 402 is composed of a semiconductor, or the dopant 502 can be an oxygen vacancy V₀ when the active region 402 is composed of an oxide. As shown in the example of FIG. 5B, when a voltage of an appropriate magnitude and polarity is applied to the electrodes 404 and 406, a drift field forms between the electrodes 404 and 406. As described above with reference to FIGS. 2 and 3, and as shown in the example of FIG. 5B, the dopant 502 becomes mobile in the active region 502, and the drift field forces the dopant 502 to drift into a subregion 504 of the active region 402 near the second electrode 406. In other embodiments, a voltage with an appropriate magnitude and opposite polarity may cause the dopant 502 to drift away from the electrode 406 in order to disperse the dopant or drive the dopant toward the first electrode 404.

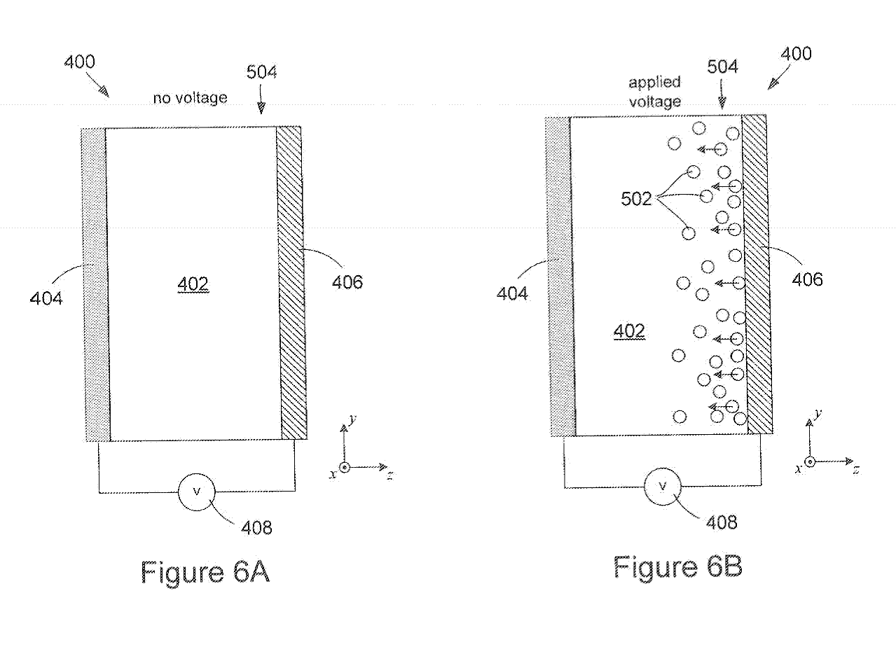

In other embodiments, when the active region 402 is composed of an undoped, or intrinsic, material, one of the two electrodes 404 and 406 can be composed of a doped semiconductor or a material that is suitable for introducing dopants to, or forming dopants within, the active region 402 while the other electrode can be composed of a suitable conducting metal. FIGS. 6A-6B show cross-sectional views of the device 400 along the line II-II, shown in FIG. 4, in accordance with embodiments of the present invention. As shown in the example of FIG. 6A, the active region 402 can be composed of an intrinsic semiconductor material or an intrinsic oxide. The second electrode 406 can be composed of a material that introduces a dopant to the subregion 504 of the active region 402. For example, in certain embodiments, the electrode 406 can be composed of a semiconductor doped with an n-type impurity or a p-type impurity. As shown in the example of FIG. 6B, when a voltage of an appropriate magnitude and polarity is applied to the electrodes 404 and 406, the dopant 502 drifts from the electrode 406 into the subregion 504 of the active region 402. In other embodiments, the active region 402 can be composed of an intrinsic oxide and the electrode 406 can be composed of Ti, Zr, Hf, or an alloy of the oxide. For example, the electrode 406 can be composed of Zr and the active region 402 can be composed of ZrO₂. FIG. 6B can represent the case that when a voltage of an appropriate magnitude is applied to the electrodes 404 and 406, Zr⁺ ions, for example, drift into the subregion 504 of the active region 402 forming oxygen vacancies 502. Reversing the polarity of the voltage may cause Zr⁺ ions to drift back into the second electrode 406 depleting the active region 402 of oxygen vacancies.

In still other embodiments, the modulating device 400 can be fabricated with dopants, or metal ions that form dopants, concentrated in a reservoir in close proximity to the electrode 406. When a voltage of an appropriate magnitude and polarity is applied, the dopants can drift into the active region 402, as shown in FIG. 6B. When the polarity of the voltage is reversed, the dopants or metal ions drift back reforming the reservoir in close proximity to the electrode 406.

### II. Modulating Device Characteristics and Operation

As described above with reference to FIGS. 1-6, the basic mode of operation of the modulating devices 100 and 400 is to apply a voltage of an appropriate magnitude and polarity to generate a corresponding electrical field across the active region 102. The magnitude and polarity of the electrical field causes a dopant to drift into or out of at least one subregion of the active region material via ionic transport. The dopant can be specifically selected to change the conductance of the subregion into which the dopant drifts. For example, applying a drift field that introduces or drives dopants into the subregions 204, 206, and 504, as described in FIGS. 2, 3, 5, and 6, increases the conductance of these subregions. In addition, the active region material and the dopant are chosen such that the drift of the dopant within the active region is possible but not too facile that a dopant can diffuse into other other subregions of the active region when no voltage is applied. Some diffusion resistance is required to ensure that the active region remains in a particular conductance state for a reasonable period of time, perhaps for many years at the operation temperature. This ensures that the active region 102 is nonvolatile because the active region 102 retains its conductance state even after the drift field has been removed.

The modulating device 100 can be characterized as a memristor because the conductance (i.e., resistance, because resistance is inversely related to the conductance) changes in a nonvolatile fashion depending on the magnitude and polarity of an electric field applied in the device 100. Memristance is a nonvolatile, charge-dependent resistance denoted by M(q). The term “memristor” is short for “memory resistor.” Memristors are a class of passive circuit elements that maintain a functional relationship between the time integrals of current and voltage, or charge and flux, respectively. This results in resistance varying according to the device's memristance function. Specifically engineered memristors provide controllable resistance useful for switching current. The definition of the memristor is based solely on fundamental circuit variables, similar to the resistor, capacitor, and inductor. Unlike those more familiar elements, the necessarily nonlinear memristors may be described by any of a variety of time-varying functions. As a result, memristors do not belong to Linear Time-Independent circuit models. A linear time-independent memristor is simply a conventional resistor.

A memristor is a circuit clement in which the ‘magnetic flux’ (defined as an integral of bias voltage over time) Φ between the terminals is a function of the amount of electric charge q that has passed through the device. Each memristor is characterized by its memristance function describing the charge-dependent rate of change of flux with charge as follows:

$$M ( q ) = \frac{d Φ}{d q}$$

Based on Faraday's law of induction that magnetic flux Φ is the time integral of voltage, and charge q is the time integral of current, the memristance can be written as

$$M ( q ) = \frac{V}{I}$$

Thus, as stated above, the memristance is simply nonvolatile charge-dependent resistance. When M(q) is constant, the memristance reduces to Ohm's Law R=VII. When M(q) is not constant, the equation is not equivalent to Ohm's Law because q and M(q) can vary with time. Solving for voltage as a function of time gives:

V(t)=M[q(t)]I(t)

This equation reveals that memristance defines a linear relationship between current and voltage, as long as charge docs not vary. However, nonzero current implies instantaneously varying charge. Alternating current may reveal the linear dependence in circuit operation by inducing a measurable voltage without net charge movement, as long as the maximum change in q does not cause change in M. Furthermore, the memristor is static when no current is applied. When I(t) and V(t) are 0, M(t) is constant. This is the essence of the memory effect.

The active region can be single crystalline, poly-crystalline, nanocrystalline, nanoporous, or amorphous. The mobility of a dopant in nanocrystalline, nanoporous or amorphous materials, however, may be much higher than in bulk crystalline material, since drift can occur through grain boundaries, or through local structural imperfections in a nanocrystalline, nanoporous, or amorphous material. Also, because the active region material is relatively thin (i.e., about 20 nm to about 50 nm), the amount of time needed for a dopant to drift within the active region material enables the active region material conductivity to be rapidly changed. For example, the time needed for a drift process varies as the square of the distance covered, so the time to drift one nanometer is one-millionth of the time to drift one micrometer.

The ability of a dopant to drift within the active region material may be improved if one of the interfaces connecting the active region 102 to a metallic or semiconductor electrode is non-covalently bonded. Such an interface may be composed of a material that does not form covalent bonds with the adjacent electrode, the active region material, or both. This non-covalently bonded interface lowers the activation energy of the atomic rearrangements that are needed for drift of the dopants in the active region.

One potentially useful property of the active region is that it can be a weak ionic conductor. The definition of a weak ionic conductor depends on the application for which the device 100 is intended. The mobility μ_{d} and the diffusion constant D for a dopant in a lattice are related by the Einstein equation:

D=μₖkT/q

where k is Boltzmann's constant, and T is absolute temperature, q the elementary charge. Thus, if the mobility μ_{d} of a dopant in a lattice is high so is the diffusion constant D. In general, it is desired for the active region 102 of the device 100 to maintain a particular conductance state for an amount of time that may range from a fraction of a second to years, depending on the application. Thus, it is desired that the diffusion constant D be low enough to ensure a desired level of stability, in order to avoid inadvertently turning the active region from one resistance state to another resistance state via ionized dopant diffusion, rather than by intentionally setting the state of the active region with an appropriate voltage. Therefore, a weakly ionic conductor is one in which the dopant mobility μ_{d} and the diffusion constant D are small enough to ensure the stability or non-volatility of the active region for as long as necessary under the desired conditions. On the other hand, strongly ionic conductors would have relatively larger dopant mobilities and be unstable against diffusion. Note that this relation breaks down at high field and the mobility becomes exponentially dependent on the field.

### III. Phase and Amplitude Modulation

The refractive index across an active region depends on the concentration and distribution of dopants within the active region. Thus, it is believed that a phase shift and/or change in the amplitude of electromagnetic radiation transmitted through an active region also depends on the concentration and distribution of dopants within the active region. In particular, the refractive index of the active region can be characterized by the complex form of the refractive index as follows:

\tilde{n}=n+iκ

The real part of the refractive index, n, equals \sqrt{εᵣμᵣ}, where εᵣ is the permittivity of the active region and μᵣ is the permeability of the active region. Typically, μᵣ≅1 leaving n≅\sqrt{εᵣ}. On the other hand, the imaginary part of the refractive index, κ, is typically referred to as the extinction coefficient, which indicates the amount of absorption or loss for electromagnetic radiation propagating through a material. Because the active region of the modulating devices are operated by altering the concentration of dopants over different subregions, and therefore the conductivity with these different subregions, the real and imaginary parts of the refractive index ñ can be approximated as functions of the conductivity as follows:

$$n ≅ \sqrt{\frac{{ɛ}^{′} + \sqrt{{ɛ}^{′2} + \frac{{σ}^{2}}{4 {ɛ}_{0}^{2} {ω}^{2}}}}{2}}$$

$$κ ≅ \sqrt{\frac{- {ɛ}^{′} + \sqrt{\frac{{σ}^{2}}{4 {ɛ}_{0}^{2} {ω}^{2}}}}{2}}$$

where ε′ is the real part of the complex permittivity and corresponds to the stored energy within the active region material, ε₀ is the permittivity in free space, σ is the conductivity of a subregion, and ω is the angular frequency of electromagnetic radiation transmitted through the active region material.

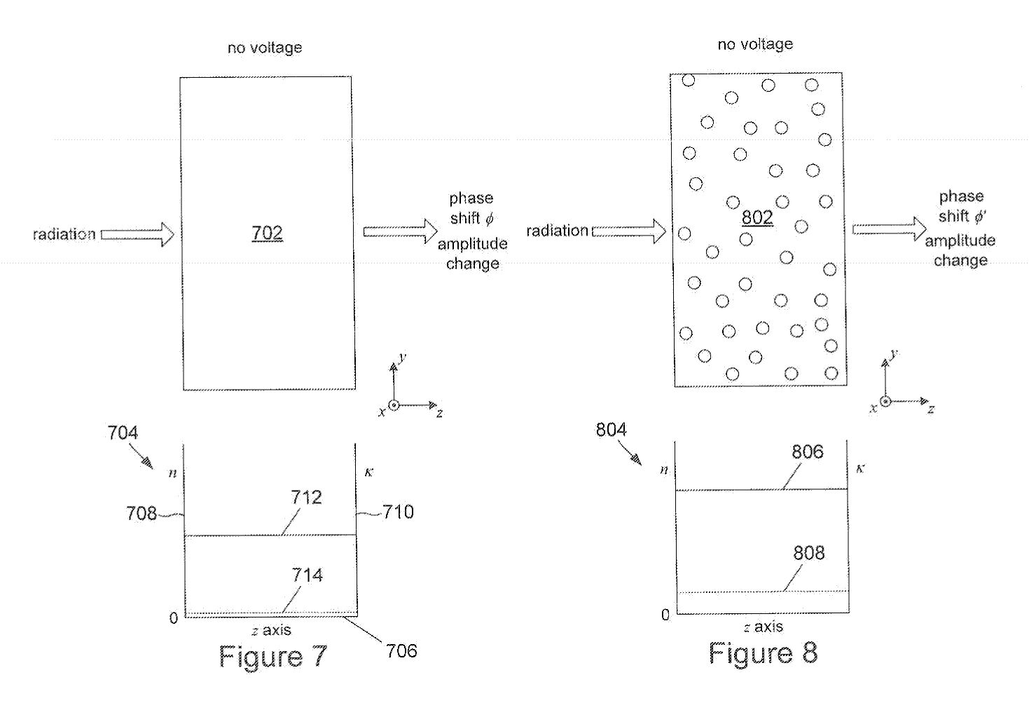

When the active region is composed of an intrinsic material, such as an intrinsic semiconductor or an intrinsic oxide, the conductivity σ is approximately “0,” which, in turns, implies the extinction coefficient κ is approximately “0” and ñ≅n. FIG. 7 shows a cross-sectional view of an active region 702 composed of an intrinsic material and a corresponding refractive index plot 704 according to the present invention. The active region 702 can represent the intrinsic active region 102 in FIG. 3A or represent the intrinsic active region 402 in FIG. 6A. The plot 704 includes an axis 706 representing the distance across the active region 702 in the z-direction, an axis 704 corresponding to the refractive index n, and an axis 708 corresponding to the extinction coefficient κ. Because the active region material is intrinsic and no voltage is applied to the active region 702, the refractive index n is substantially constant throughout the active region 702, as represented by a line 712, and the extinction coefficient κ may be small across the active region 702, as represented by line 714. As shown in the example of FIG. 7, electromagnetic radiation emerging from the active region 702 acquires a phase shift φ, and the amplitude of the emerging electromagnetic radiation may be less than the amplitude of the impinging electromagnetic radiation.

When the active region is composed of a doped material, such as a semiconductor doped with a n-type or p-type dopant or an oxide with oxygen vacancies, the conductivity σ may be larger than for an intrinsic material. FIG. 8 shows a cross-sectional view of an active region 802 composed of a doped material and a corresponding refractive index plot 804 according to the present invention. The active region 802 can represent the active region 102 in FIG. 2A, or represent the active region 402 in FIG. 5A. As shown in the example of FIG. 8, because the dopant is nearly evenly distributed throughout the active region material and no voltage is applied to the active region 802, the refractive index n is substantially constant over the active region 802, as represented by a line 806 in the plot 804. However, because the dopant increases the conductivity of the active region 802, the extinction coefficient κ is non-zero and substantially constant over the active region 802, as represented by line 808 in the plot 804. The dopant corresponds to a greater loss in the electromagnetic radiation passing through the active region 802 than the loss created by the active region 702, which, as described above, is composed of substantially intrinsic material. Thus, comparing plots 704 and 804 reveals that the active region 802 has a relatively larger refractive index n and extinction coefficient κ than the refractive index n and extinction coefficient κ associated with the active region 702. Electromagnetic radiation passing through the active region 802 acquires a phase shift φ′, and because of the optical loss associated with the greater conductivity of the active region 802, the amplitude of the emerging electromagnetic radiation is less than the amplitude of the impinging electromagnetic radiation.

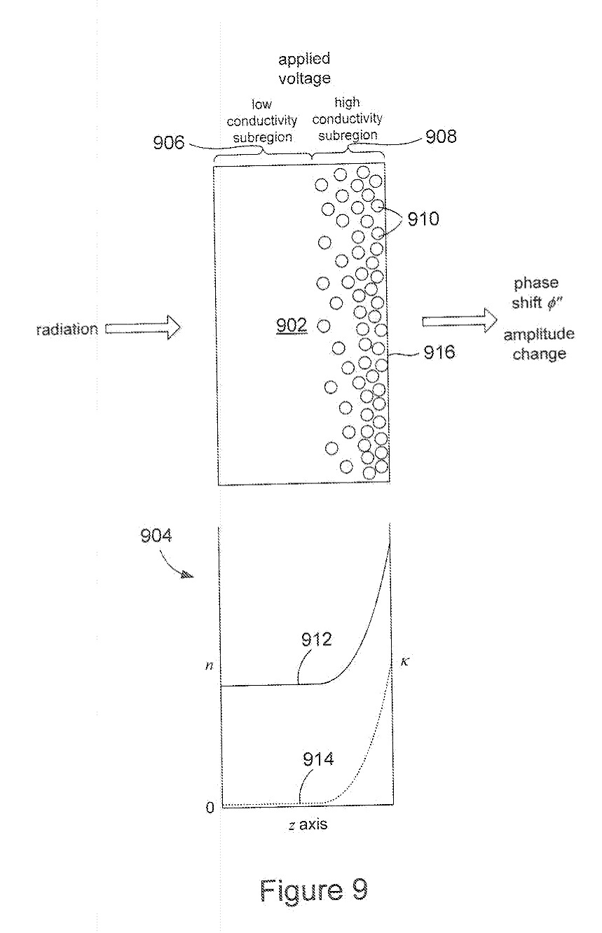

On the other hand, when the dopant of the active region is concentrated in a subregion of the active region, as described above with reference to FIGS. 2B, 3B, 5B and 6B, the conductivity over the subregion is different from the conductivity over other subregions of the active region. FIG. 9 shows a cross-sectional view of an active region 902 with an unevenly distributed dopant and a corresponding refractive index plot 904 according to the present invention. The active region 902 represents the active regions shown in FIGS. 2B, 3B, 5B, and 6B. As shown in the example of FIG. 9, the active region 902 includes a very low conductivity subregion 906 substantially free of dopants and includes a relatively higher conductivity subregion 908 having a relatively high concentration of dopants 910. Thus, as indicated in the plot 904, the real part of the refractive index n 912 is approximately constant across the subregion 906 and the extinction coefficient κ 914 is small across the subregion 906. However, because the dopant 910 concentration increases within the subregion 908 toward edge 916, the conductivity σ correspondingly increases over the subregion 908. Thus, as shown in the plot 904, in accordance with the increase in conductivity σ over the subregion 908, both the refractive index n and the extinction coefficient κ increase over the subregion 908. The electromagnetic radiation acquires a phase shift φ″ and because of the optical loss caused by the dopant, the amplitude of the emerging electromagnetic radiation is less than the amplitude of the impinging electromagnetic radiation.

Note that because the concentration of dopants within the subregion 908 is greater than the concentration of dopants within the active region 702 and 802, the subregion 908 can have a considerably larger conductivity σ than the active regions 702 and 802. Thus, the optical loss may be greater over the subregion 908 than the optical loss associated with the active regions 702 and 802.

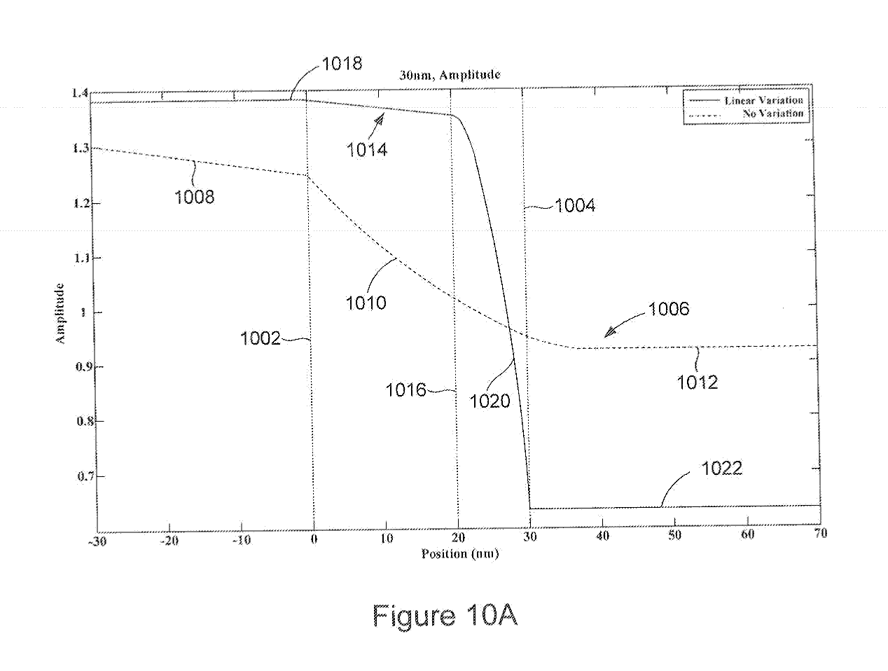

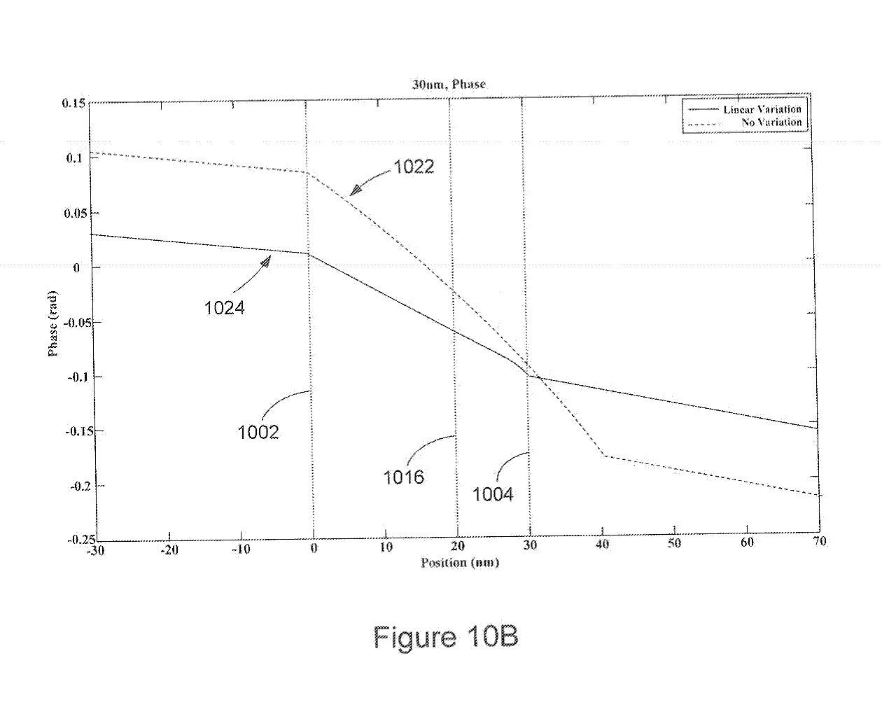

FIGS. 10A-10B show simulation results for electromagnetic radiation transmitted through a hypothetical 30 nm thick active region of TiO₂ as a function of the oxygen vacancy distribution in accordance with embodiments of the present invention. In the plot represented in FIG. 10A, dotted line 1002 at 0 nm represents the incident surface of the active region, and dotted line 1004 at 30 nm represents the surface of the active region from which electromagnetic radiation emerges. Dashed curve 1006 represents the amplitude of electromagnetic radiation transmitted through an active region composed of intrinsic TiO₂. Negatively sloped portion 1008 reveals a gradual decrease in the amplitude of the incident electromagnetic radiation prior to reaching the incident surface of the active region due to a portion of the incident electromagnetic radiation being reflected back and destructively interfering with the incident electromagnetic radiation. Curved portion 1010 corresponds to absorption and destructive interference within the active region due to internal reflection. Finally, flat portion 1012 represents the amplitude of transmitted electromagnetic radiation. On the other hand, solid curve 1014 represents the amplitude of electromagnetic radiation transmitted through an active region of width 30 nm, where the active region between 0 and 20 nm is composed of intrinsic TiO₂, but the oxygen vacancy concentration increases linearly between 20 nm, represented by dotted line 1016, and 30 nm. A substantially flat, linear portion 1018 indicates that very little amplitude or power in the incident electromagnetic radiation is lost due to destructive interference prior to reaching the active region and between 0 nm and 20 nm. However, steeply curved portion 1020 indicates a considerable portion of the amplitude of the electromagnetic radiation is lost within the conductive subregion of the active region resulting a relative lower amplitude represented by linear portion 1022 than the amplitude 1012.

In the plot represented in FIG. 10B, dashed curve 1022 represents the phase change in electromagnetic radiation transmitted through the active region composed of intrinsic TiO₂, and solid curve 1024 represents the phase change in the electromagnetic radiation transmitted through the active region where the active region between 0 and 20 nm is composed of intrinsic TiO₂, but the oxygen vacancy concentration increases linearly between 20 nm and 30 nm. Comparing curve 1022 with curve 1024 reveals that intrinsic TiO₂ may introduce a relatively larger phase change than an active region having a linear concentration of oxygen vacancies between 20 and 30 nm.

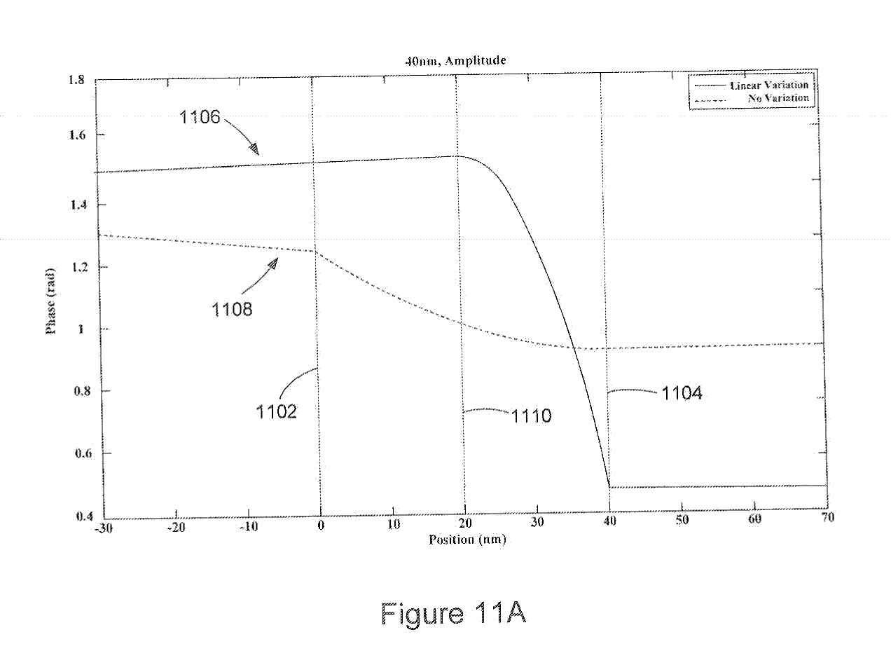

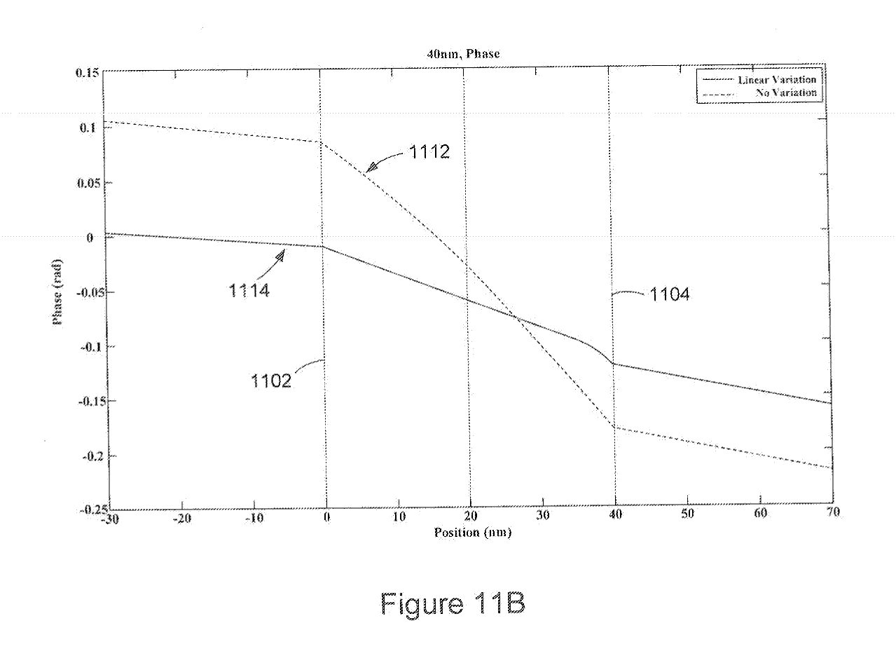

FIGS. 11A-11B show plots of simulation results characterizing how amplitude and phase, respectively, of electromagnetic radiation arc affected by an active region composed of TiO₂ with a thickness of 40 nm in accordance with embodiments of the present invention. In the plots represented in FIG. 11A-11B, dotted line 1102 at 0 nm represents the incident surface of the active region, and dotted line 1104 at 40 nm represents the surface of the active region from which electromagnetic radiation emerges. In FIG. 11A, dashed curve 1006 represents the amplitude of electromagnetic radiation transmitted through an active region composed of intrinsic TiO₂. Solid curve 1108 represents the amplitude of electromagnetic radiation transmitted through an active region, where the active region between 0 and 20 nm is composed of intrinsic TiO₂, but the oxygen vacancy concentration increases linearly between 20 nm, represented by dotted line 1110, and 40 nm. Curves 1106 and 1108 reveal substantially the same general effects on the amplitude as represented by the curves 1006 and 1014, respectively, shown in FIG. 10A.

In the plot represented in FIG. 11B, dashed curve 1112 represents the phase change in electromagnetic radiation transmitted through the active region composed of intrinsic TiO₂, and solid curve 1114 represents the phase change in the electromagnetic radiation transmitted through the active region where the active region between 0 and 20 nm is composed of intrinsic TiO₂, but the oxygen vacancy concentration increases linearly between 20 nm and 40 nm. Comparing curve 1112 with curve 1114 reveals the same general changes in the phase as curves 1022 and 1024, shown in FIG. 10B. In other words, intrinsic TiO₂ may introduce a relatively larger phase change than an active region having a linear concentration of oxygen vacancies between 20 and 40 nm.

### IV. Applications

Electronically modulating devices configured in accordance with embodiments of the present invention can be operated in an external modulator by placing the modulating device in the paths of an unmodulated carrier wave of electromagnetic radiation and placing the modulating device in electronic communication with an electronic signal source. Electronic signals generated by the electronic signal source are applied to the device electrodes in order to shift the refractive index ñ of the active region, as described in the preceding subsection, resulting in corresponding phase and/or amplitude changes in the carrier waves. The resulting electromagnetic wave encodes the same information as the electronic signal. Embodiments of the present invention also include arranging the modulating devices in an array. By dynamically controlling the application of appropriate electronic signals to the individual modulating devices, the wavefront of electromagnetic radiation passing through the array can be dynamically changed to generate holographic images.

### A. Modulators

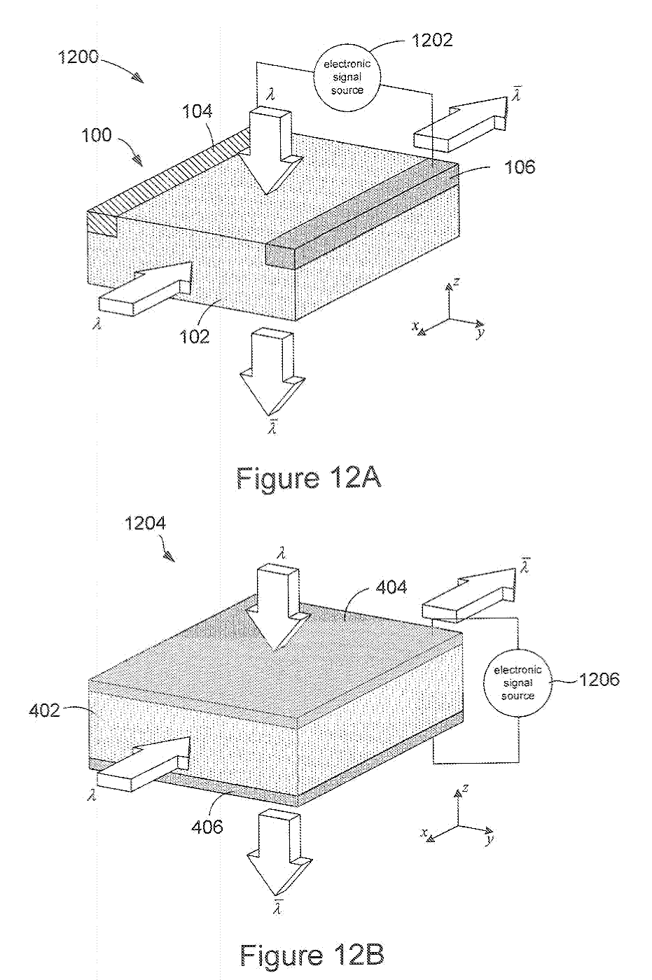

FIG. 12A shows a modulator 1200 configured in accordance with embodiments of the present invention. The modulator 1200 includes the modulating device 100 in electronic communication with an electronic signal source 1202. FIG. 12B shows a modulator 1204 configured in accordance with embodiments of the present invention. The modulator 1204 includes the modulating device 400 in electronic communication with an electronic signal source 1206. As shown in the examples of FIGS. 12A-12B, an unmodulated carrier wave of electromagnetic radiation, denoted by λ, can be input in the z-direction or input within the xy-plane of the devices 100 and 400. Depending on the materials selected for the active regions 102 and 402, and the materials selected for the electrodes, electronic signals generated by the electronic signals sources 1202 and 1206 are applied to the electrodes of the devices 100 and 400 and correspondingly change the refractive index ñ of the active regions 102 and 402 as described above. These changes in the refractive index ñ produce corresponding changes in the phase and/or amplitude of the carrier wave λ transmitted through the devices 100 and 400. As a result, an electromagnetic signal, denoted by λ̅, emerges from the devices 100 and 400 is phase and/or amplitude modulated and encodes the same information as the electronic signal. FIG. 12 includes the electromagnetic signals λ̅ emerging from the devices 100 and 400 and corresponding to carriers waves input in the z- and x-directions.

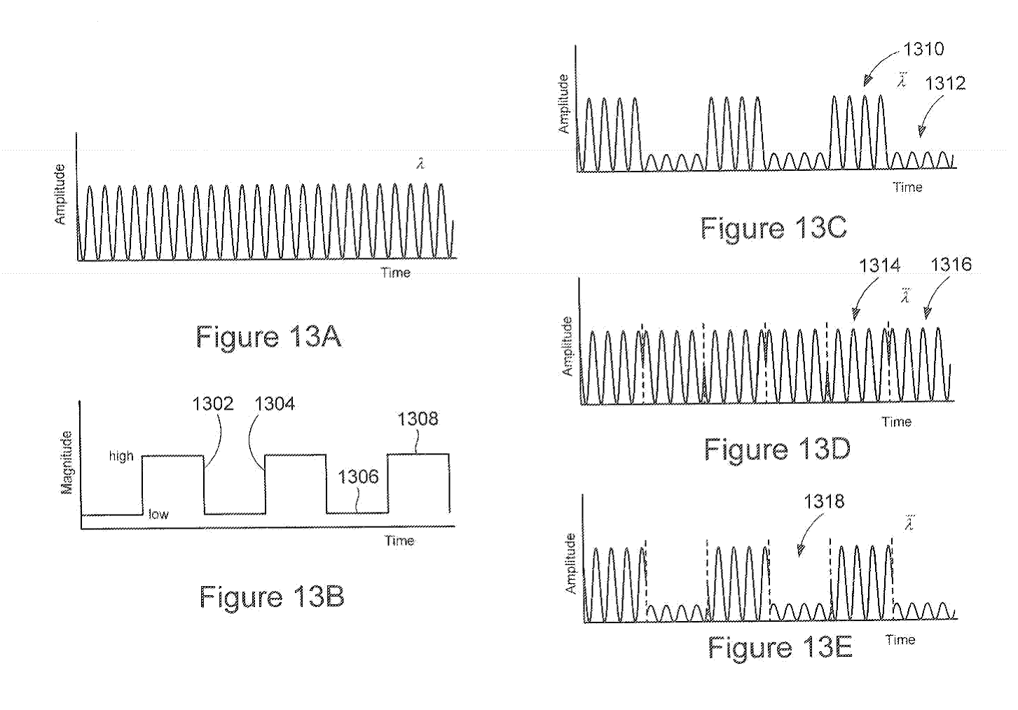

FIGS. 13A-13E show plots of examples of amplitude, phase, and amplitude/phase modulated electromagnetic signals. FIG. 13A shows an amplitude versus time plot of an unmodulated carrier wave λ of electromagnetic radiation output from an electromagnetic radiation source. The portion of the carrier wave shown in FIG. 13A represents an ideal case where the amplitude and phase of the carrier wave remain substantially unchanged prior to passing through a modulating device of a modulator configured in accordance with embodiments of the present invention.

FIG. 13B shows an electronic signal versus time plot. The electronic signal can be generated by an electronic signal source, such as source 1202 and 1206, and applied to the electrodes of a modulating device of a modulator. Data can be encoded in variations in magnitude of an electronic signal or in constant magnitude portions of an electronic signal. For example, in certain embodiments, a high magnitude to a low magnitude transition 1302 in the electronic signal can represent binary number “0,” and low magnitude to a high magnitude transition 1304 in the electronic signal can represent binary number “1.” In other embodiments, a sustained low magnitude portion 1306 of the electronic signal for a period of time can represent the binary number “1,” and a sustained high magnitude portion 1308 of the electronic signal for a period of time can represent the binary number “0.”

FIG. 13C shows a plot of an amplitude modulated electromagnetic signal output from a modulating device of a modulator. The high and low amplitude portions of a modulated electromagnetic signal correspond to the low and high magnitude portions, respectively, of the electronic signal shown in FIG. 13B. In other words, a modulating device can be operated, as described above in subsection III, so that the refractive index ñ is small for low magnitude portions of the electronic signal and relatively larger for high magnitude portions of the electronic signal. Thus, a relatively high amplitude portion 1310 of the electromagnetic signal corresponds to small real and imaginary parts of the refractive index ñ and a low magnitude portion 1306 of the electronic signal shown in FIG. 13B. A relatively low amplitude portion 1312 of the electromagnetic signal corresponds to relatively larger real and imaginary parts of the refractive index ñ and a high magnitude portion 1308 of the electronic signal shown in FIG. 13B.

FIG. 13D shows a plot of a phase modulated electromagnetic signal output from a modulating device of a modulator. For simplicity in the following description, changes in the refractive index ñ of the active region produce half-wavelength phase shifts. For example, when a high magnitude portion 1308 of the electronic signal is applied to an modulating device, the real and imaginary parts of the refractive index ñ over a subregion of the active region increase introducing a half-wavelength phase shift in the carrier wave as indicated by the half-wavelength phase difference in portions 1314 and 1316 of the electromagnetic signal.

FIG. 13E shows a plot of an amplitude and a phase modulated electromagnetic signal output from an modulating device of a modulator. As shown in FIG. 13E, the relatively low amplitude portions of the electromagnetic signal, such as portion 1318, can be generated as described above with reference to FIG. 13C, and the half-wavelength phase differences between the low amplitude portions and the relatively higher amplitude portions result from refractive index n changes described above with reference to FIG. 13D.

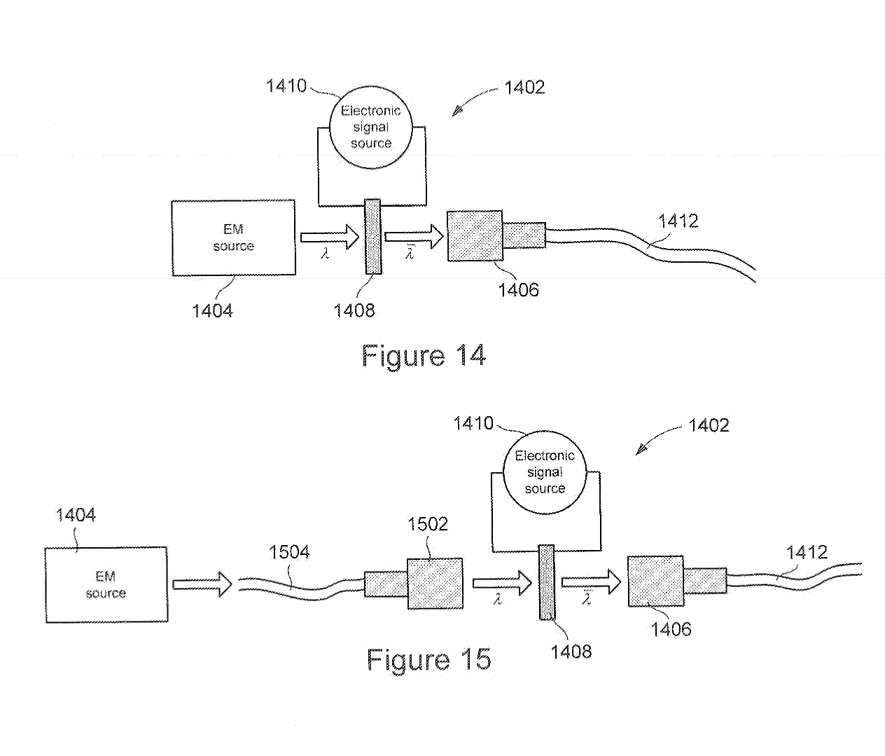

In certain implementation embodiments, the modulators 1200 and 1204 can be implemented by simply inserting the modulating devices 100 and 400 in the path of a beam of unmodulated electromagnetic radiation in order to produce modulated electromagnetic radiation, as described above. In other embodiments, the modulators 1200 and 1204 can be implemented by inserting the modulating devices between an electromagnetic radiation source and an optical fiber collimator. FIG. 14 shows a schematic representation of a modulator 1402 inserted between an electromagnetic radiation source 1404 and an optical fiber collimator 1406 in accordance with embodiments of the present invention. The modulator 1402 is composed a modulating device 1408 and an electronic signal source 1410. The modulating device 1408 can be configured and operated as described above. The electromagnetic radiation source 1404 emits an unmodulated carrier electromagnetic wave λ. Electronic signals generated by the electronic signal source 1410 shift the refractive index ñ of the device 1408 as described above to produce an electromagnetic signal λ̅ encoding the same information as the electronic signal. The electromagnetic signal is input to optical fiber 1412 via the fiber collimator 1406, where the electromagnetic signal can be carried to a destination device for processing.

FIG. 15 shows a schematic representation of the modulator 1402 inserted between the fiber collimator 1406 and a second optical fiber collimator 1502 in accordance with embodiments of the present invention. The electromagnetic radiation source 1404 emits an unmodulated carrier wave λ or electromagnetic radiation that is carried by an optical fiber 1504 to fiber collimator 1502. The carrier wave is modulated by the modulating device 1408 as described above with reference to FIG. 14.

### B. Dynamically Reconfigurable Holograms

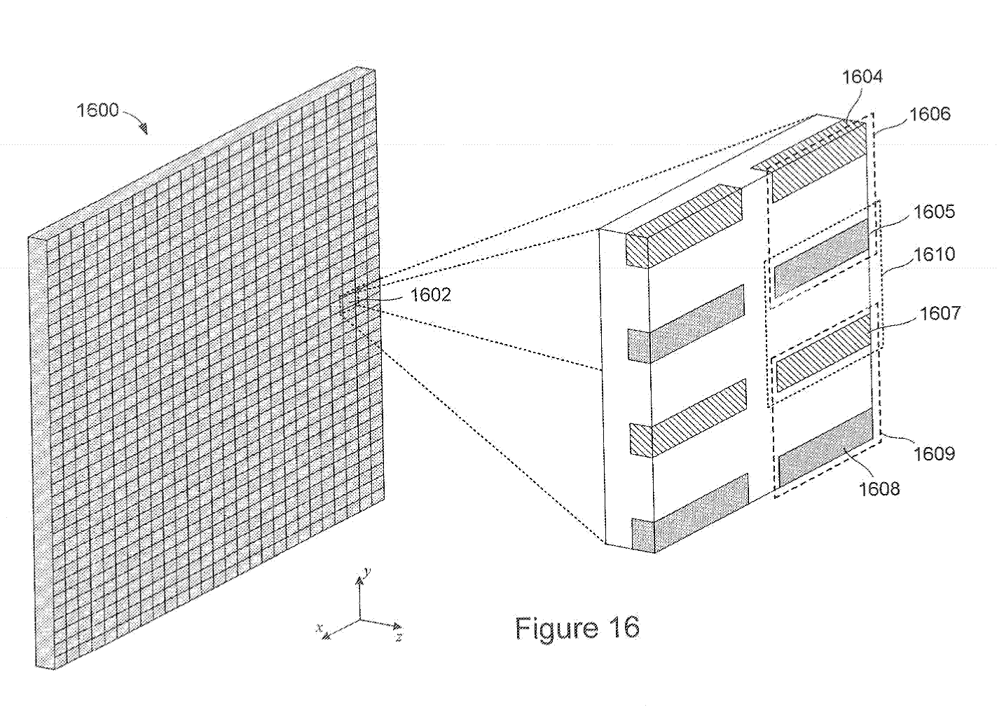

FIG. 16 shows an isometric view of an electronically controlled hologram 1600 composed of modulating devices in accordance with embodiments of the present invention. As shown in FIG. 16, the hologram 1600 is composed of a regular array of rectangles 1602, each rectangle representing a number of modulating devices configured as described above with reference to the modulating device 100 in FIGS. 1-3. FIG. 16 includes an enlargement of the rectangle 1602, which reveals four to six modulating devices, depending on how the individual electrodes are operated. In certain embodiments, only pairs of electrodes can be operated to form modulating devices. For example, pairs of electrodes 1604 and 1605 can be operated to form the modulating device 1606, and pairs of electrodes 1607 and 1608 can be operated to form the modulating device 1609. In other embodiments, the electrodes can be individually operated such that pairs of electrodes 1605 and 1607 also form a modulating device 1610. Each of the actuated devices of the hologram 1600 can be individually operated to modulate the phase and/or amplitude of electromagnetic radiation transmitted through the hologram 1600.

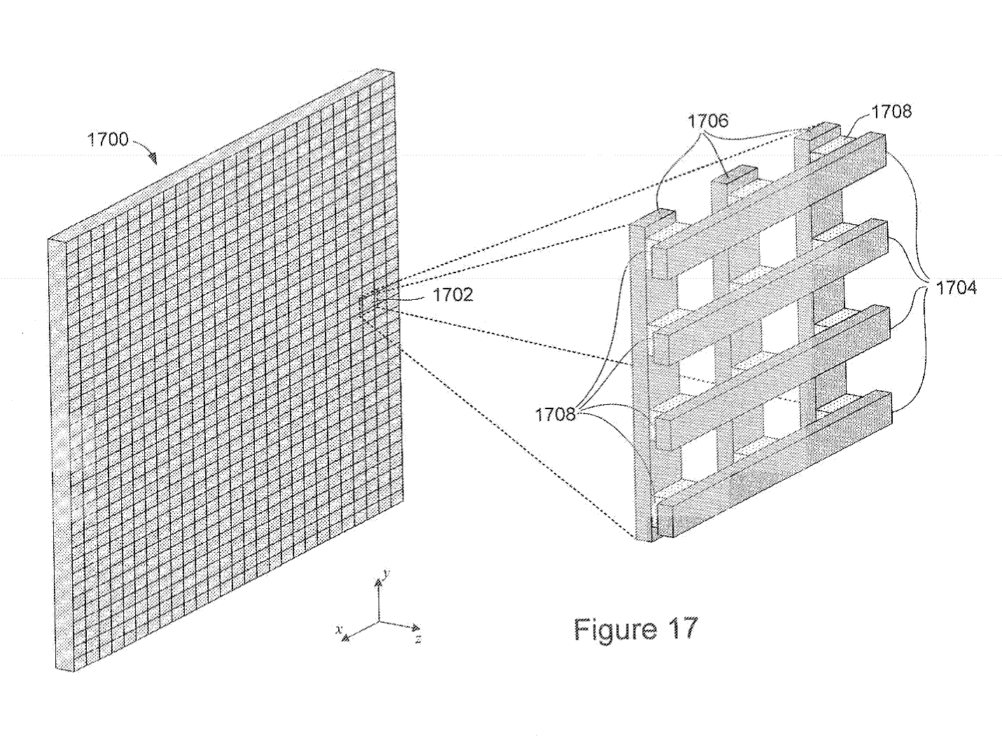

FIG. 17 shows an isometric view of an electronically controlled hologram 1700 composed of modulating devices in accordance with embodiments of the present invention. The hologram 1700 is also composed of a regular array of rectangles 1702, however, each rectangle in this embodiment represents 12 modulating devices configured in accordance with the modulating device 400 described above with reference to FIGS. 4-6. FIG. 17 includes an enlargement of the rectangle 1702 revealing that the hologram 1700 comprises a first layer of non-crossing, approximately parallel nanowires 1704 that overlay a second layer of non-crossing, approximately parallel nanowires 1706. The nanowires of the first layer 1704 run substantially parallel to the x-axis and are approximately perpendicular in orientation to the nanowires of the second layer 1706, which run substantially parallel to the y-axis, although the orientation angle between the nanowires of the layers 1704 and 1706 may vary. The two layers of nanowires form a lattice, or crossbar, with each nanowire of the first layer 1704 overlying the nanowires of the second layer 1706 and coming into close contact with each nanowire of the first layer 1704 at nanowire intersections 1708. Each nanowire intersection forms an modulating device that is configured to operate as described above with reference to the modulating device 400 and can be individually operated to modulate the phase and/or amplitude of electromagnetic radiation transmitted through the hologram 1700.

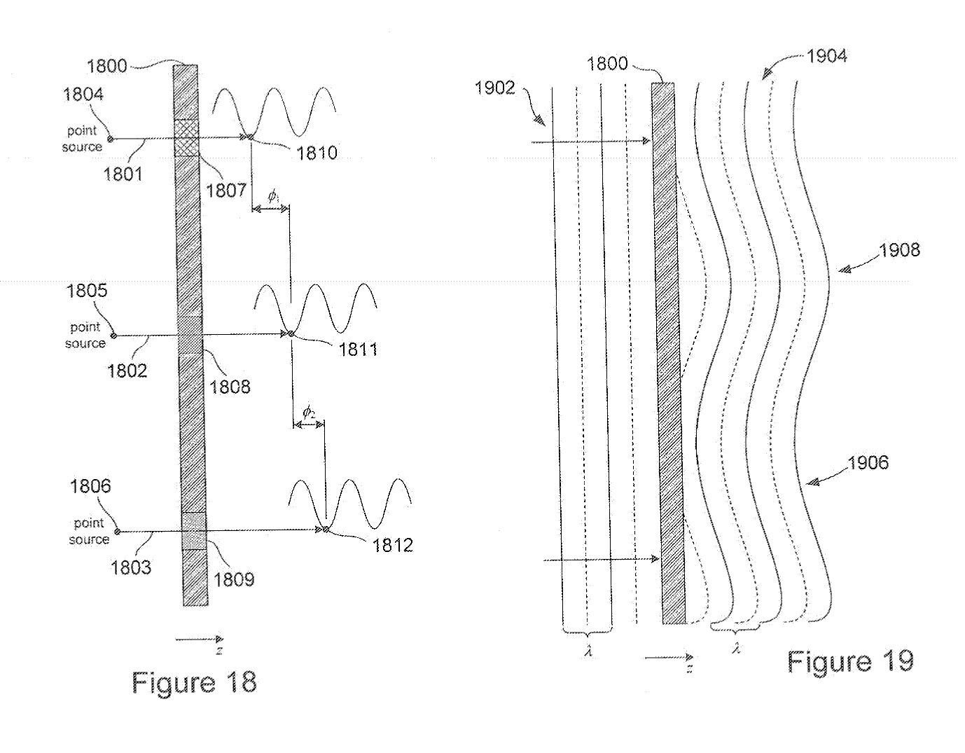

FIG. 18 shows a side view of rays of electromagnetic radiation transmitted through three modulating devices of a hologram 1800 operated in accordance with embodiments of the present invention. The hologram 1800 can represent the hologram 1600 or the hologram 1700. Rays 1801-1803 emanating from electromagnetic radiation point sources 1804-1806 pass through modulating devices 1807-1809, respectively. In the example shown in FIG. 18, each of the modulating devices 1807-1809 can be separately and electronically addressed, as described above, and introduces a different phase to the rays 1801-1803, respectively. As shown in the example of FIG. 18, points 1810-1812 represent points on electromagnetic waves that simultaneously enter the modulating devices 1807-1809, respectively, but due to the different refractive indices at the modulating devices, the points 1810-1812 of the electromagnetic waves emerge at different times from the modulating device 1807-1809 and, therefore, arc located at different distances from the hologram 1800. In other words, the electromagnetic waves emerging from the modulating devices 1807-1809 acquire different transmission phase shifts. The relative phase difference between the electromagnetic waves emerging from modulating device 1807 and 1808 is φ₁, and the relative phase difference between electromagnetic waves emerging from modulating device 1808 and 1809 is φ₂, with the greatest relative phase difference of φ₁+φ₂ associated with electromagnetic waves emerging from modulating devices 1807 and 1809. The electronic signals applied to the modulating devices 1807-1809 can be rapidly modulated, which, in turn, rapidly modulates the refractive indices of the modulating devices 1807-1809 resulting in rapid changes in relative phase differences between rays emerging from the modulating device 1807-1809.

FIG. 19 shows a side view of quasimonochromatic electromagnetic radiation entering and emerging from the hologram 1800 in accordance with embodiments of the present invention. A quasimonochromatic beam of electromagnetic radiation enters the hologram 1800 with substantially uniform wavefronts 1902. Each wavefront crest is identified by a solid line and each wavefront trough is identified by a dashed line. Each wavefront enters the hologram 1800 with substantially the same phase. The modulating devices (not identified) of the hologram 1800 are selectively addressed to produce non-uniform wavefronts 1904. The non-uniform wavefronts 1904 can result from certain regions of the incident uniform wavefronts 1902 passing through modulating devices that have been electronically configured with relatively different refractive indices. For example, regions of non-uniform wavefronts in region 1906 emerge from the hologram 1800 later than regions of non-uniform wavefronts in region 1908. In other words, the hologram 1800 is configured to introduce relatively large transmission phase differences between regions of wavefronts emerging in region 1906 and regions of wavefronts emerging in region 1908.

The hologram 1800 can be operated by a computing device that allows a user to electronically address each resonant element as described above with reference to FIG. 17. In practice, the computing device can be any electronic device, including, but not limited to: a desktop computer, a laptop computer, a portable computer, a display system, a computer monitor, a navigation system, a personal digital assistant, a handheld electronic device, an embedded electronic device, or an appliance.

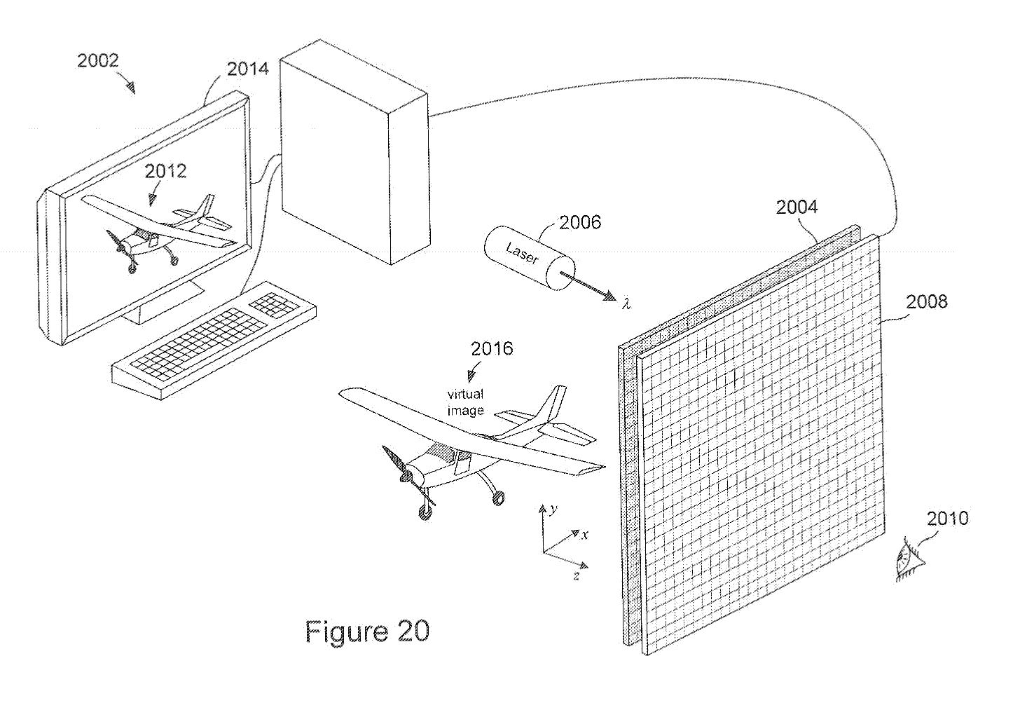

FIG. 20 shows an example of a system for generating three-dimensional color holographic images in accordance with embodiments of the present invention. The system comprises a desktop computer 2002, an electronically controlled hologram 2004, and a electromagnetic radiation source 2006, such as laser. The computer 2002 includes a processor and memory that process and store data representing various images of objects and scenes. The images are stored in the memory as data files comprising three-dimensional coordinates and associated intensities and color values. As shown in FIG. 20, an electronically controlled, intensity-control layer 2008 can be arranged with respect to the hologram 2004 to generate full-color holographic images.

The intensity-control layer 2008 can be a liquid crystal layer configured to control red, green, and blue wavelengths emerging from the modulating devices of the hologram pass through intensity-control elements of intensity-control layer 2008. Each individual intensity-control element of the intensity-control layer can be configured and operated to output and vary the intensity of red, green, or blue wavelengths of electromagnetic radiation transmitted through one or more modulating devices in order to produce substantially full color pixels. Each intensity-control element of intensity-control layer may be composed of a layer of liquid crystal molecules aligned between two transparent electrodes and two polarizing filters with substantially perpendicular axes of transmission. The electrodes are composed of a transparent conductor such as Indium Tin Oxide (“ITO”).

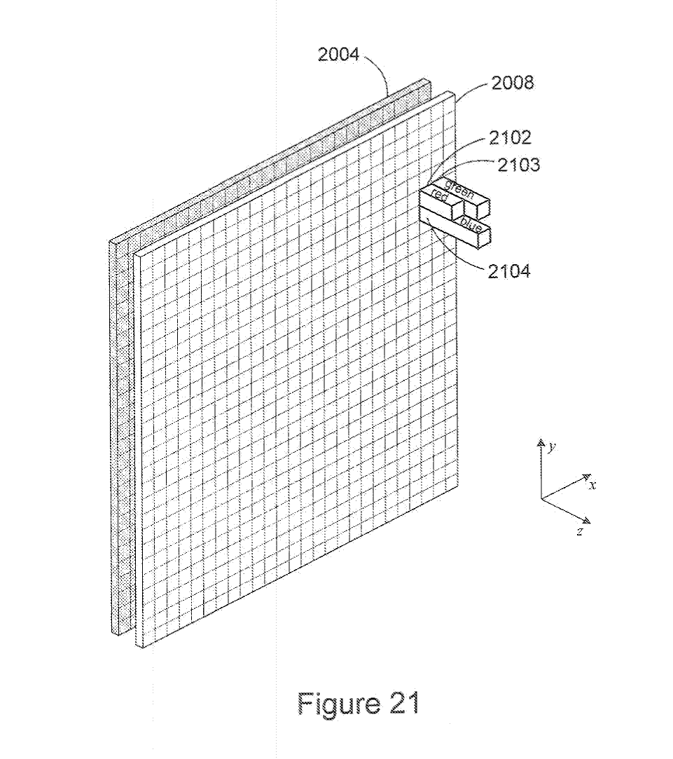

FIG. 21 shows intensity levels associated with red, green, and blue wavelengths passing through modulating devices of the hologram 2004 and intensity-control elements of intensity-control layer 2008 in accordance with embodiments of the present invention. The electromagnetic radiation emerging from modulating devices in hologram 2004 passes through intensity-control elements 2102-2104 that are each configured to produce a different primary color intensity level. As shown in FIG. 21, bars labeled red, green, and blue may represent red, green, and blue intensity levels associated with a single color pixel. In other embodiments, the number of intensity-control elements used to generate a primary color pixel can vary. To a viewer positioned a distance away from the hologram 2008, the electromagnetic radiation emerging from the intensity-control elements 2102-2104 is mixed, and therefore, the viewer perceives a single color pixel rather than the individual colors comprising the pixel.

Returning to FIG. 20, a three-dimensional image of an object can be displayed on one side of the hologram 2004 as follows. The electromagnetic radiation source 2006 is positioned and configured to emit quasimonochromatic electromagnetic radiation that passes through the electronically addressed hologram 2004 and intensity-control layer 2008. A program stored on the computer system memory displays the image as a three-dimension object by translating the data files into electronic addresses that are applied to particular modulating elements of the hologram 2004 and intensity-control elements of the layer 2008. Electromagnetic radiation passing through each modulating device and intensity-control element acquires an appropriate transmission phase and primary color intensity in order to generate the wavefront reflected by an object and intensity mapping over a range of viewing angles. As a result, the image stored in the computer is perceived by a viewer 2010 as a virtual three-dimensional color holographic image of an object suspended behind the hologram 1400. For example, as shown in FIG. 20, the computer 2002 displays a two-dimensional image of an airplane 2012 on a monitor 2014 and displays a virtual three-dimensional color holographic image 2016 of the same airplane on the side of the hologram 2008 opposite the viewer 2010. The viewer 2010 looking at the hologram 2008 perceives the airplane 2016 in depth by varying the position of her head or changing her perspective of the view. In other embodiments, two or more color holographic images can be displayed. In addition, because the hologram 1400 is dynamically controlled and the refractive index of the modulating devices can be rapidly changed, color holographic motion pictures can also be displayed.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention arc presented for purposes of illustration and description. They are not intended to be exhaustive of or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A modulating device (100) comprising:
a first electrode (104);
a second electrode (106); and
an active region (102), wherein the first electrode (104) and the second electrode (106) are located on the same side of the active region (102) and portions of the first and second electrodes are embedded within the active region such that at least a portion of the active region is disposed between the first electrode and the second electrode, wherein a voltage of an appropriate magnitude and polarity applied to the electrodes changes the conductivity within subregions of the active region, which in turn shifts the phase and/or amplitude of electromagnetic radiation transmitted through the active region.

2. The device of claim 1 wherein the active region further comprises a semiconductor material and a dopant (202,502) disposed within the semiconductor material.

3. The device of claim 1 wherein the first electrode and the second electrode further comprise electrically conducting metals.

4. The device of claim 1 wherein the first electrode (104) further comprises a material that introduces dopants to the active region when the voltage is applied and the second electrode further comprises a conducting metal.

5. The device of claim 1 wherein applying a voltage of an appropriate magnitude and polarity to the electrodes further comprises change the conductivity of the active region by driving dopants into a subregion of the active region.

6. An external modulator (1200,1204) comprising:
a first electrode (104,404);
a second electrode (106,406);
an active region (102,402); and
an electronic signal source (1202,1206) electronically coupled to the first electrode and the second electrode, wherein the electronic signal source is configured to apply an electronic signal to the first electrode and the second electrode changing the conductivity within subregions of the active region, which in turn shifts the phase and/or amplitude of electromagnetic radiation transmitted through the active region.

7. The external modulator of claim 6 wherein the electronic signal applied to the modulating device modulates the phase and/or amplitude of a carrier wave of electromagnetic radiation transmitted through the modulating device such that an electromagnetic signal emerges from the modulating device encoding the same information as the electronic signal.

8. The external modulator of claim 6 wherein the active region further comprises a semiconductor material and a dopant (202,502) disposed within the semiconductor material.

9. The external modulator of claim 6 wherein the first electrode (104,406) further comprises a material that introduces dopants to the active region when the voltage is applied and the second electrode further comprises a conducting metal.

10. The external modulator of claim 6 wherein the first electrode (104) and the second electrode (106) are located on the same side of the active region (102) and portions of the first and second electrodes are embedded within the active region such that at least a portion of the active region is disposed between the first electrode and the second electrode

11. The external modulator of claim 6 wherein the first electrode (404) and second electrode (406) are located on opposite sides of the active region.

12. A dynamically reconfigurable hologram (1600,1700) comprising:
a two-dimensional array of modulating devices, each modulating device comprising:
a first electrode (104,404),
a second electrode (106,406), and
an active region (102,402), wherein a voltage of an appropriate magnitude and polarity applied to the electrodes changes the conductivity within subregions of the active region, which in turn shifts the phase and/or amplitude of electromagnetic radiation transmitted through the active region; and
an intensity-control layer (2008) including a two-dimensional array of intensity-control elements (2102-2104), wherein one or more three-dimensional motion pictures can be produced by electronically addressing the individual modulating devices and intensity-control elements in order to phase shift and control the intensity of electromagnetic radiation emanating from the hologram.

13. The reconfigurable hologram of claim 12 wherein each intensity-control clement of the intensity control layer is configured to electronically output and modulate a red, green, or blue intensity level of wavelengths of electromagnetic radiation output from one or more modulating devices of the two-dimensional array of modulating elements in order to generate color motion pictures.

14. The reconfigurable hologram of claim 12 wherein the first electrode (104) and the second electrode (106) are located on the same side of the active region (102) and portions of the first and second electrodes arc embedded within the active region such that at least a portion of the active region is disposed between the first electrode and the second electrode

15. The reconfigurable hologram of claim 12 wherein the first electrode (404) and second electrode (406) are located on opposite sides of the active region.
